(19) United States
(12) Patent Application Publication
(10) Pub. No.: US 2015/0099567 A1
(43) Pub. Date: Apr. 9, 2015

(54) METHOD OF GAMING

(71) Applicant: Cherif Atia Algreatly, Newark, CA (US)

(72) Inventor: Cherif Atia Algreatly, Newark, CA (US)

(21) Appl. No.: 14/495,903

(22) Filed: Sep. 25, 2014

Related U.S. Application Data
(60) Provisional application No. 61/961,315, filed on Oct. 9, 2013.

(51) Int. Cl. A63F 13/80; A63F 13/537

(52) U.S. Cl. CPC A63F 13/80; A63F 13/537
USPC 463/9

(57) ABSTRACT

Disclosed is a method of gaming comprised of; presenting a plurality of objects and adjacency requirements representing the adjacency between the objects; receiving a user's solution or answer aimed at accurately representing the positions of the objects relative to each other; and checking the user's solution against the adjacency requirements. The objects can be virtual objects presented on a computer display. The objects can also be real objects equipped with a display which presents the adjacency requirements necessary and sensors to detect the positions of the objects relative to each other.

### CROSS-REFERENCE TO RELATED APPLICATION

This application claims the benefits of a U.S. Provisional Patent Application No. 61/961,315, filed Oct. 9, 2013.

### BACKGROUND

Arranging a plurality of objects relative to one another to reflect certain adjacency requirements is a common process in various design fields such as building design, interior design, mechanical design and electronic design. Students and professionals of such design fields are required to skillfully transform an adjacency design problem into a design solution. An adjacency design problem is usually described through a variety of formats including tables, diagrams, or a statement to indicate the objects of design elements that are required to be connected to each other. The design solution is typically provided as a freehand sketch, drawing or 3D model. Until now no game has been created to train students and designers to test their skills when it comes to solving adjacency design problems. If there were a game that urges students and professional designers to strengthen their adjacency problem solving talents and ultimately increase their productivity through an enhanced understanding, it would be incredibly useful.

### SUMMARY

The present invention discloses a game representing an adjacency problem. In one embodiment, the adjacency problem is represented by a bubble diagram, where each bubble or circle represents an object and each line connecting two bubbles represents an adjacency requirement between these two objects. In another embodiment, the adjacency problem is represented by a plurality of objects in the form of geometrical shapes, each of which includes the names or tags of other objects that must be attached to it. In one embodiment, the adjacency problem is represented by a table which includes the names of the objects and the adjacency requirements between certain objects displayed by the table. In yet another embodiment, the adjacency problem is represented by a statement indicating the objects that must to be adjacent or attached. The user of the game provides the solution of the adjacency problem by arranging the objects as deemed necessary according to the adjacency requirements set by the game.

The adjacency problem and solution can be presented in two-dimensions or three-dimensions. Two-dimensional adjacency problems are represented by two dimensional objects that have a required position in a two-dimensional plan, relative to each other. Three-dimensional adjacency problems are represented by three-dimensional objects that are required to be positioned in three-dimensions relative to each other.

The game has different levels that include requirements other than the adjacency requirements. For example, the game may require the user to position the objects of the adjacency problem in a particular container abiding to certain boundary lines and dimensions of the container. The game may also require the user to position particular objects in certain directions while completing the specific adjacency requirements of the objects. Additionally, the game may require the user to change the shape or dimensions of the object without changing the object's area in order to reach the design solution.

In one embodiment, the game appears as a computer game where the user's solution is automatically checked and a message appears on the computer display indicating if the user's solution is right or wrong. In another embodiment, the game consists of actual objects equipped with sensors that sense their adjacency and directions relative to each other and generate a signal indicating if the user has correctly arranged them according to the problem requirements. In yet another embodiment, the game is presented as a printed paper that includes the description of the adjacency problem and the user makes use of a pencil to draw the game's solution on the printed paper. To graphically differentiate between the various objects of the game problem, each object is given a unique color, identity, or shape.

The above Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF DRAWINGS

FIG. 1 illustrates an example of an adjacency problem which presents three objects that must be attached to each other according to certain adjacency requirements.

FIG. 2 illustrates connecting the first object to the second object.

FIG. 3 illustrates connecting the third object to the second object.

FIG. 4 illustrates moving the third object to another position so it is attached to both the first object and second object.

FIG. 5 illustrates an adjacency problem that requires four objects to be attached to each other according to the tags that are located on each one of the objects.

FIG. 6 illustrates a solution to the problem: objects are attached to each other in a way that achieves the adjacency requirements of the tags.

FIG. 7 illustrates an alternative solution for the same problem.

FIG. 8 illustrates a plurality of 3D objects attached to each other in three dimensions to achieve certain adjacency requirements of a problem.

FIG. 9 illustrates an adjacency problem presented as a bubble diagram.

FIG. 10 illustrates a solution to the adjacency problem where the objects are attached to each other according to the adjacency requirements indicated in the bubble diagram.

FIG. 11 illustrates an example of a multi-level bubble diagram.

FIG. 12 illustrates another format of the game that can be printed on papers, newspapers or magazines.

FIG. 13 illustrates the solution of the previous adjacency problem.

FIG. 14 illustrates a table represents the bubble diagram of FIG. 13.

FIG. 15 illustrates a list of statements represent the bubble diagram of FIG. 13.

FIG. 16 illustrates an example of a bubble diagram which indicates the adjacency requirements of a plurality of hexagon objects.

FIG. 17 illustrates a solution for the previous problem.

FIG. 18 illustrates an example of a bubble diagram which indicates the adjacency requirements of a plurality of triangle objects.

FIG. 19 illustrates a solution for the previous problem.

FIG. 20 illustrates a bubble diagram of an adjacency problem where some circles or objects are associated with one or more directions.

FIG. 21 illustrates a solution for the previous problem where the positions of the objects achieve both of the adjacency and view requirements.

FIG. 22 illustrates an adjacency problem indicated by a bubble diagram, four objects, and a container.

FIG. 23 illustrates the solution for the previous problem so that the four objects fit inside the container.

### DETAILED DESCRIPTION OF INVENTION

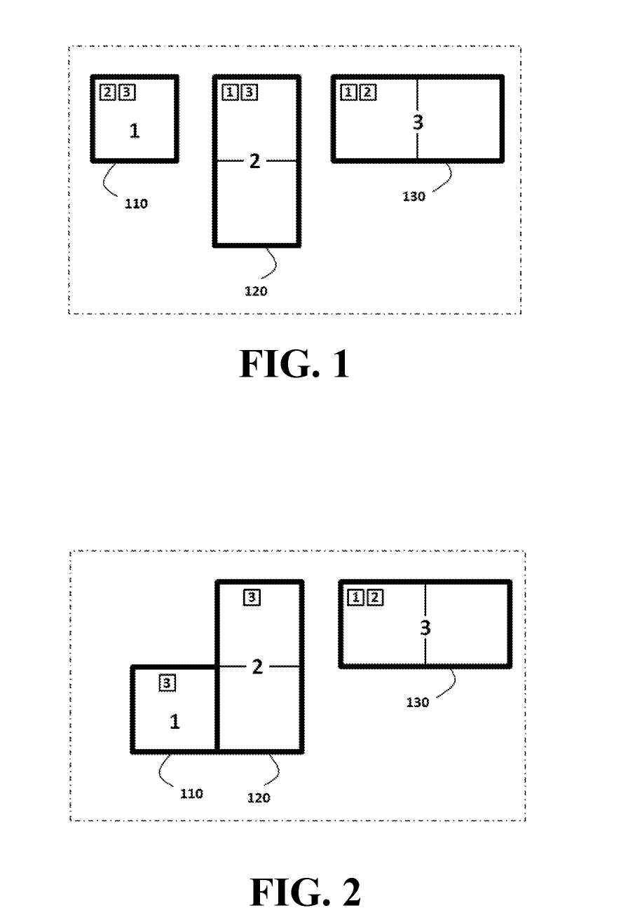

FIG. 1 illustrates an example of an adjacency problem which presents three objects 110 to 130 that are required to be attached according to certain adjacency requirements. As shown in the figure, each object is given an identifier from 1 to 3, in addition to, a number of tags representing the identifiers of other objects that must be attached to it. For example, the first object is tagged with the identifier numbers 2 and 3, meaning that the first object needs to be attached to the second and third objects. The second object is tagged with the identifier numbers 1 and 3, meaning the second object needs to be attached to the first and third objects. The third object is tagged with the identifier numbers 1 and 2, meaning the third object needs to be attached to both the first and second objects.

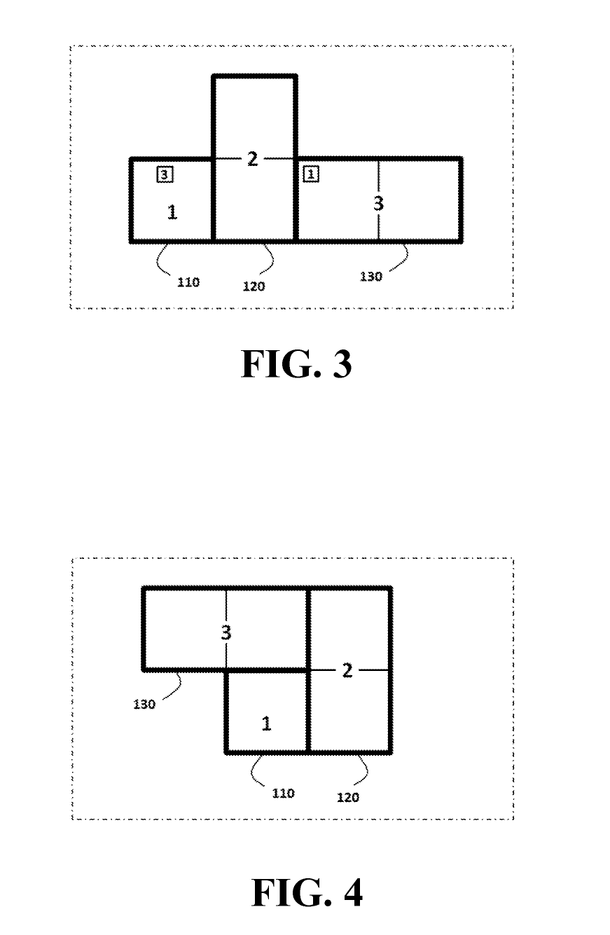

If this example is presented on a computer display, the user can move the objects on the computer display to attach them to each other in a way that achieves the adjacency requirements necessitated by the tags. For example, FIG. 2 illustrates moving the first object so that it is attached to the second object. When the connection is made, the tag on the first object that represents the second object disappears. Also, the tag on the second object that represents the first object disappears. FIG. 3 illustrates moving and attaching the third object to the second object. At this moment, the tag displayed on the second object which represents the third object disappears. The tag on the third object representing the second object disappears as well. As shown in the figure, two tags still appear on the first object and third object to indicate that the adjacency requirements have not yet been completely achieved. In other words, this is not an acceptable solution for this adjacency problem, as the first object and third object are still need to be connected.

FIG. 4 illustrates moving the third object to another position so that it is attached to both the first and second objects. As shown in the figure, all the tags disappear, indicating that all the adjacency requirements of the game have been met. At this moment, the method of the present invention displays a message indicating that the problem's solution has been reached. In this case, another adjacency problem may be presented with a greater number of objects or more complex design requirements, as will be described subsequently. Generally, the tags of the objects can be in formats other than numerals. For example, each object may have a unique color and the tag that represents the object contains the same color of that object. Accordingly, in FIG. 1 if the first, second, and third objects respectively have red, blue, and yellow colors, the tags of the first object will be blue and yellow, the tags of the second object will be red and yellow, and the tags of the third object will be red and blue.

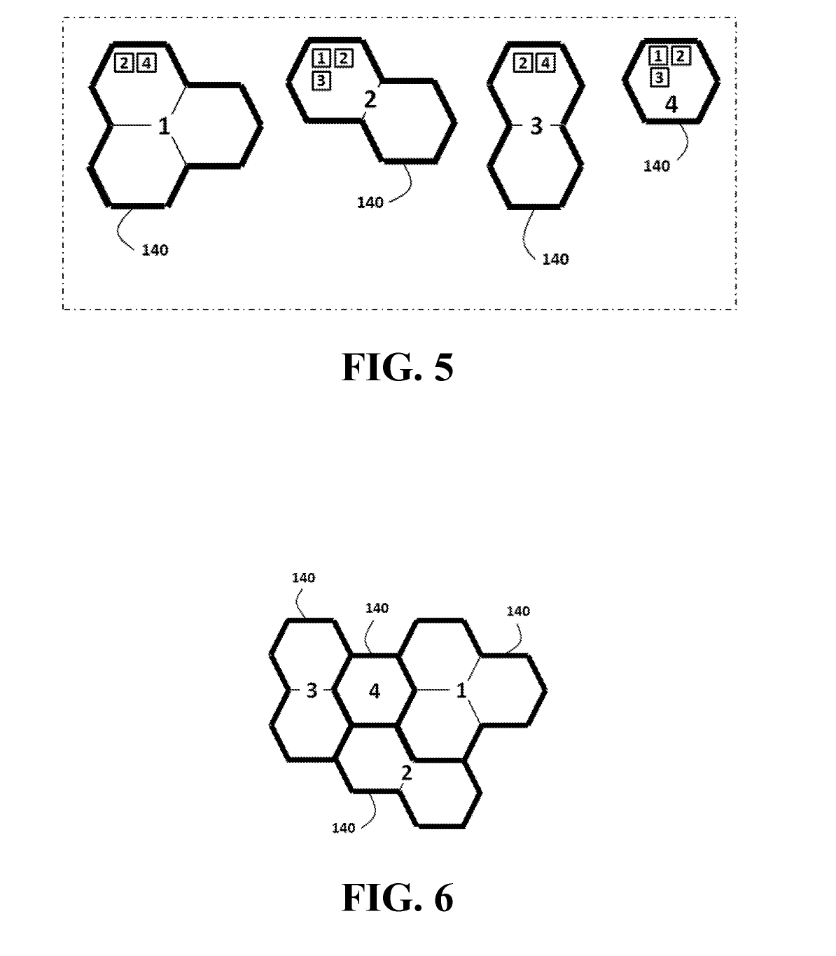

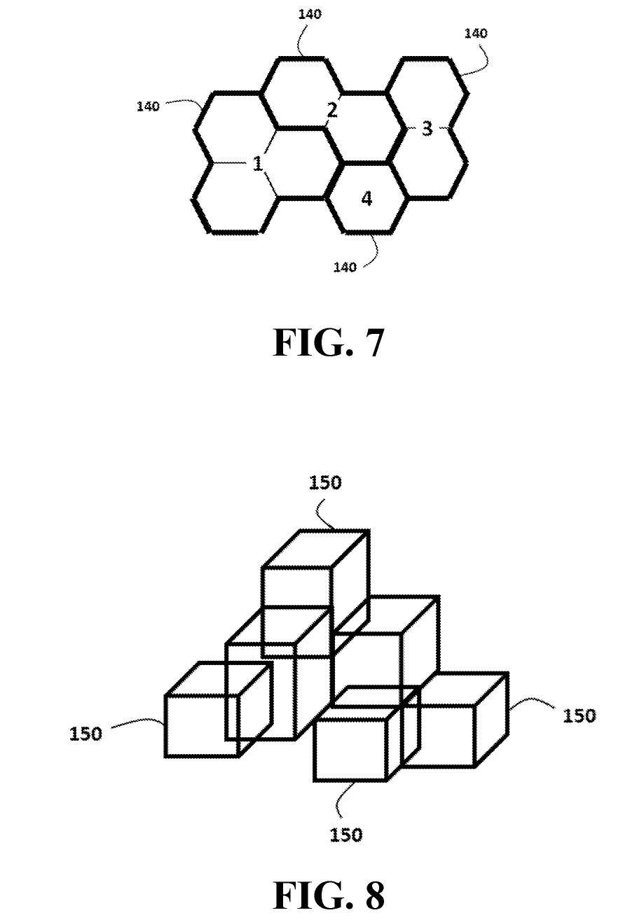

FIG. 5 illustrates another adjacency problem that includes four objects 140 which are required to be attached according to the tags or the small squares located on each one of the objects. FIG. 6 illustrates a solution for the problem where the objects are attached to each other such that the adjacency requirements indicated on the tags are met. Once this solution is reached, all the tags disappear to indicate that the user has correctly solved the adjacency problem. FIG. 7 illustrates another solution for the same problem where all the adjacency requirements are also achieved. Generally, some adjacency problems have multiple solutions and expressing just one of these multiple solutions is enough for the user to move on to another problem or level within the game.

In one embodiment of the present invention, as shown in the previous examples, the objects of the adjacency problem are presented in the form of two-dimensional shapes such as rectangles, hexagons, octagons or circles. These two-dimensional shapes are positioned on a two-dimensional plane to achieve the adjacency requirements. In another embodiment of the present invention, the objects of the adjacency problem appear in the form of three-dimensional shapes such as cubes, cuboids, prisms, pyramids or spheres. In such a case, the three-dimensional shapes are positioned in three-dimensions beside or above each other to achieve the adjacency requirements. For example, FIG. 8 illustrates a plurality of 3D objects 150 attached to each other in three dimensions to achieve certain adjacency requirements of a problem. In this case, each 3D object can be moved along the x, y, and z-axis until the adjacency requirements of the problem are resolved.

In yet another embodiment, the objects consist of two-dimensional objects classified into groups, where each group is positioned on a separate two-dimensional layer such that all the layers are positioned on top of each other. This is similar to how an architect designs a multiple floor building, where each floor has its own spaces and the different floors are positioned on top of each other. In this case, the spaces of the same floor have their own adjacency requirements, while some spaces on different floors such as bathrooms or kitchens must be vertically adjacent, or located on top of each other for the purpose of function.

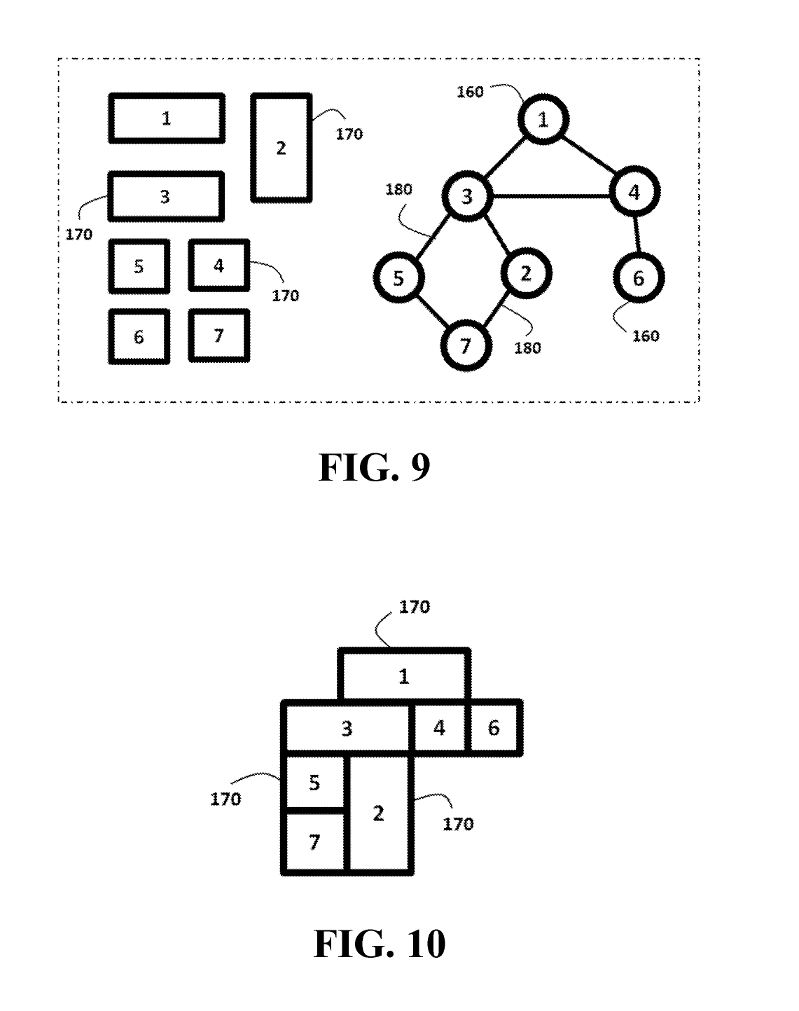

As previously mentioned, the adjacency problem can be presented in various formats other than the tags illustrated in FIGS. 1 and 5. For example, FIG. 9 illustrates an adjacency problem presented as a bubble diagram. Each circle 160 of the bubble diagram represents an object 170 with a unique ID, and the line 180 between each two circles or objects represents a requirement to attach the two objects. The attachment between two objects means the two objects share a line or part of a line in their boundary lines. FIG. 10 illustrates a solution for this problem where the objects are attached to each other according to the adjacency requirements indicated in the bubble diagram.

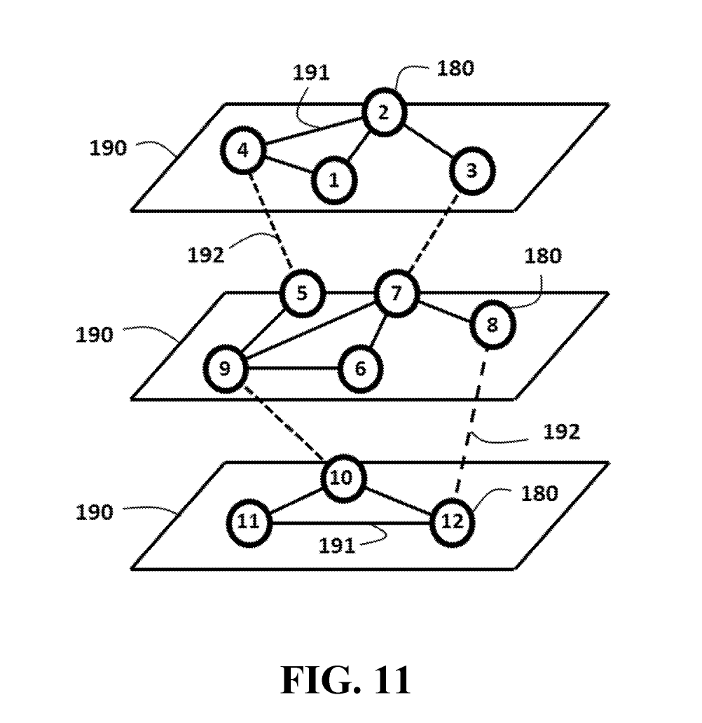

FIG. 11 illustrates another example of a multi-level bubble diagram which represents different groups of two-dimensional objects 180 each of which is positioned on a separate two-dimensional layer 190, where all the layers are positioned on top of each other. The line 191 connecting two spaces that are located in the same layer represents a horizontal adjacency between the two objects. The dotted line 192 connecting two spaces that are located in separate layers represents a vertical adjacency between the two objects. As such, the user is forced to consider horizontal and vertical adjacencies when positioning any objects.

The game of the present invention can be presented on a display of a computer, tablet or mobile phone where the user's solution is automatically checked against the adjacency requirements. In another embodiment, the game is presented on real objects equipped with a small digital display and sensors. The small digital display presents the tags of the adjacency problem, and the sensors sense the adjacency of the objects relative to each other. Using real objects provides the user with a better visualization experience especially when dealing with a multi-level bubble diagram. The real objects can also be equipped with magnets which are attached to each other from the sides, an important aspect for representing three-dimensional adjacency problems.

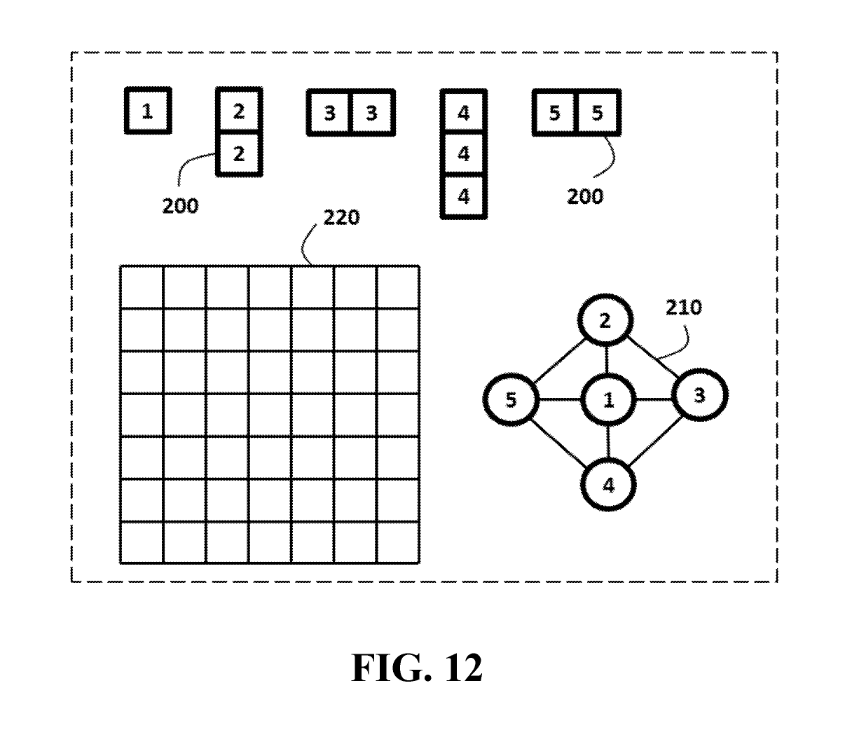

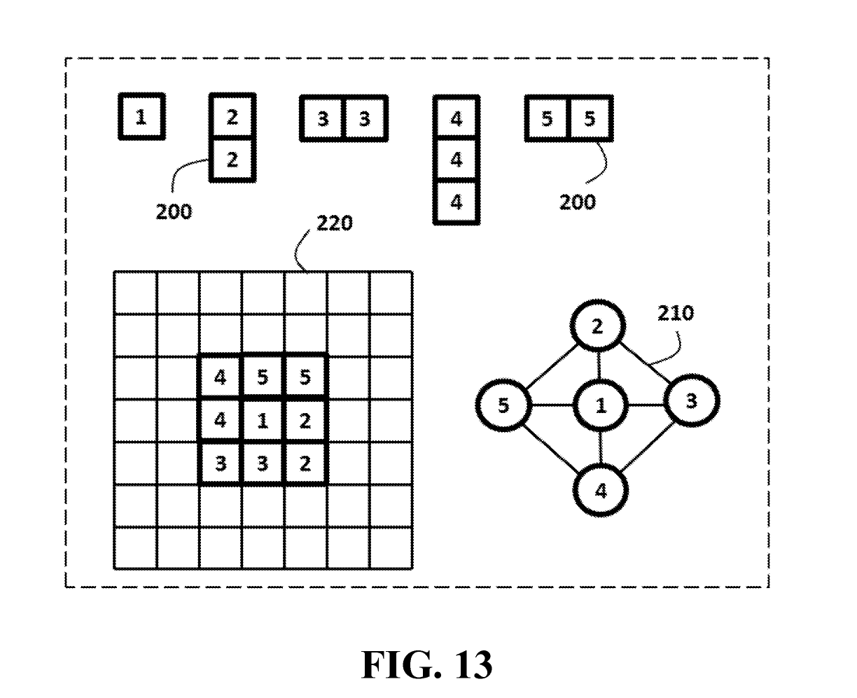

FIG. 12 illustrates another format of the present game that can be printed on paper, newspaper or magazines. As shown in the figure, a plurality of shapes 200 represents objects which are divided into identical units. Each unit includes a numeral representation of the ID of the shape or object. A bubble diagram 210 is also provided to show the adjacency problem. The grid 220 shown in the figure is the area where the user can mark or draw the solution of the problem. FIG. 13 illustrates the solution of this adjacency problem. As shown in this solution, the shapes or objects are marked or drawn relative to each other to achieve the adjacency requirements presented by the bubble diagram. The numerals of the objects help the user to visually identify each drawn object and check the solution against the adjacency requirements.

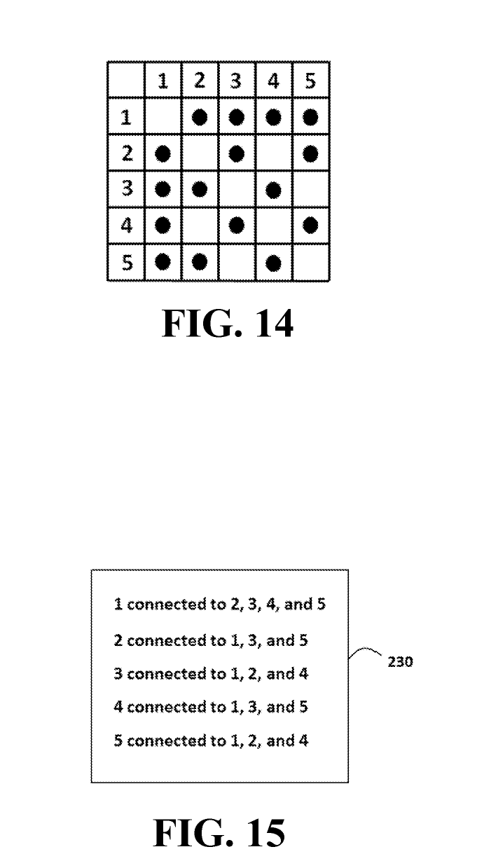

The bubble diagrams of all the previous examples can be replaced with tables or statements that indicate the adjacency requirements of the problem. For example, FIG. 14 illustrates a table that represents the bubble diagram of FIG. 13, where the black circle in the table indicates two objects that must be connected to each other. FIG. 15 also illustrates a list of statements 230 representing the bubble diagram of FIG. 13. All such formats of bubble diagrams, tablets or statements are simply means of describing the adjacency requirements of the game problem.

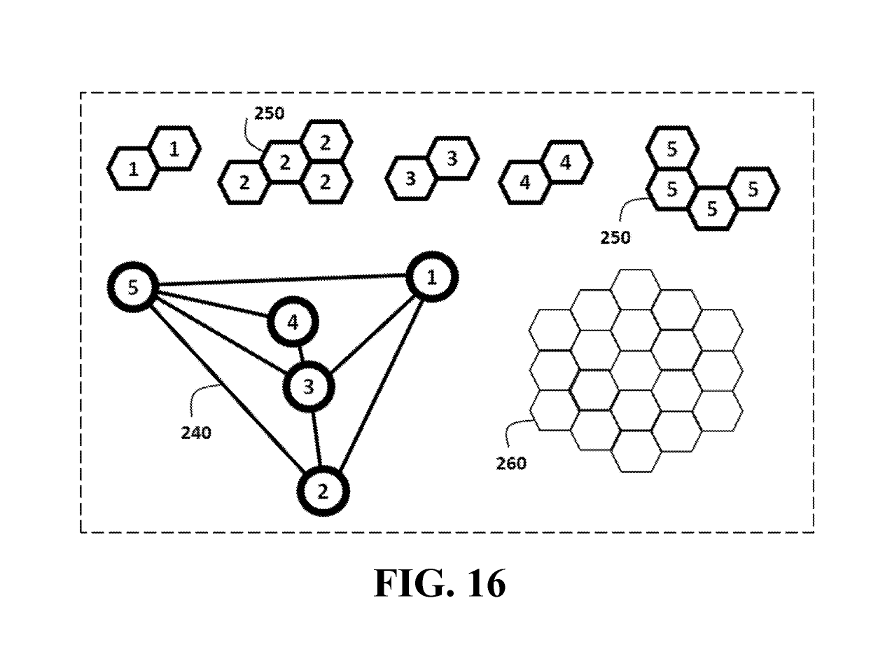

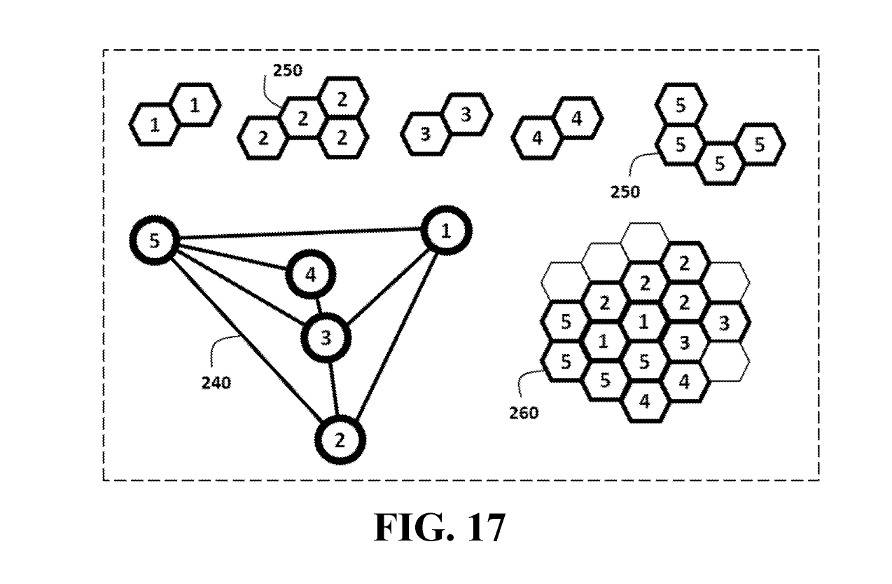

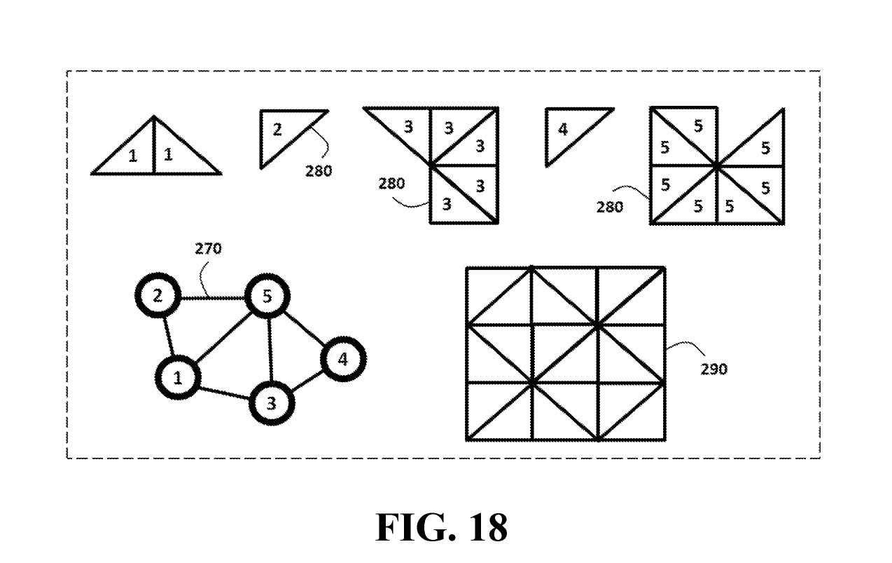

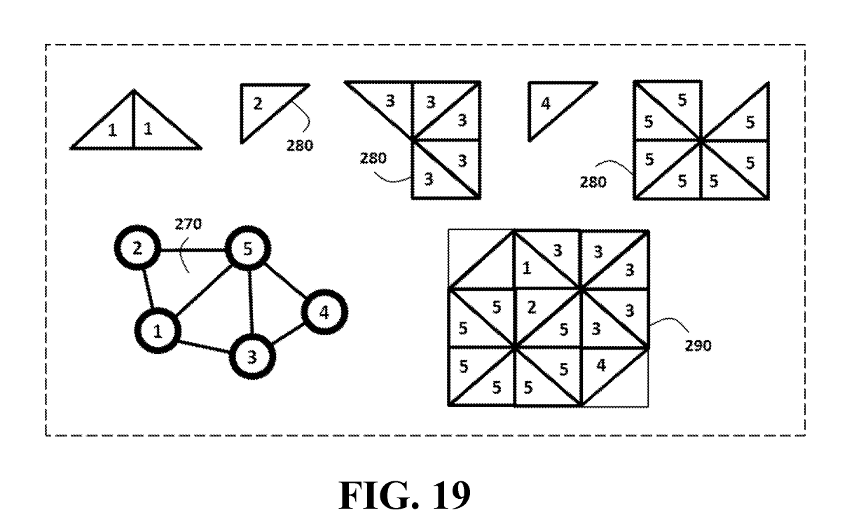

FIG. 16 illustrates a bubble diagram 240 indicating the adjacency requirements of a plurality of objects 250 which are shown as hexagons and the grid 260 of this problem is also displayed in units of hexagons to suit the shapes of the objects. FIG. 17 illustrates the solution of this problem. FIG. 18 illustrates an example of a bubble diagram 270 indicating the adjacency requirements of a plurality of objects 280 in the form of triangles. The grid 290 of this problem is also in the form of triangle units to suit the shapes of the objects. FIG. 19 illustrates the solution to this problem. Generally, the objects can be different shapes to create various problems, and the grid is comprised of similarly shaped units in which to position or maneuver the objects.

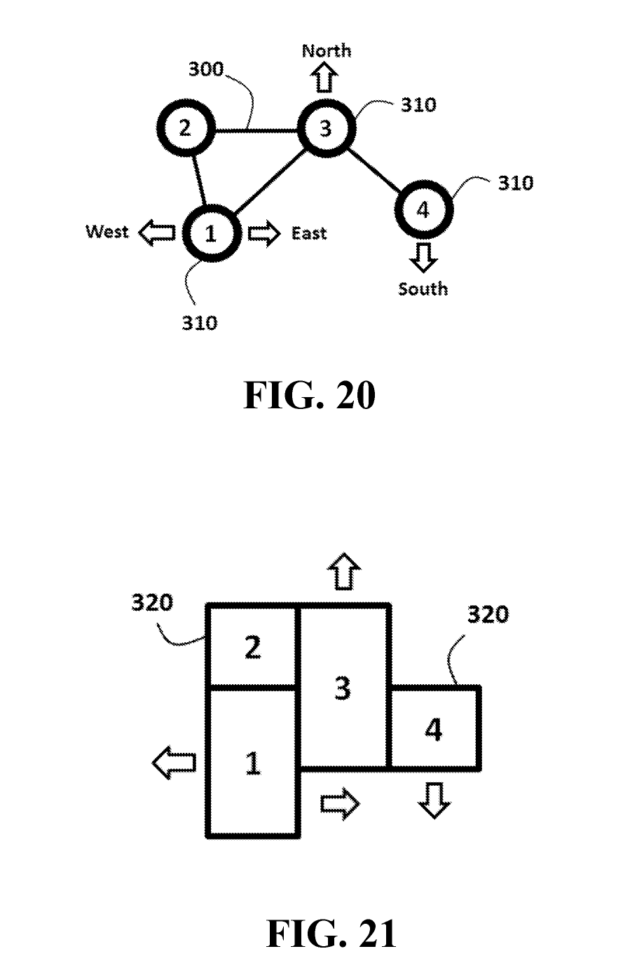

In one embodiment of the present invention, the game problem includes more requirements than the adjacency requirements, such as geographical directions or views. For example, FIG. 20 illustrates a bubble diagram 300 of an adjacency problem where some circles are associated with one or more directions such as North, South, East, or West. In this case, the solution for the problem should achieve the adjacency requirements and the view requirements set by the bubble diagram. For example, FIG. 21 illustrates a solution of this problem so the positions of the objects 320 achieve both the adjacency and view requirements.

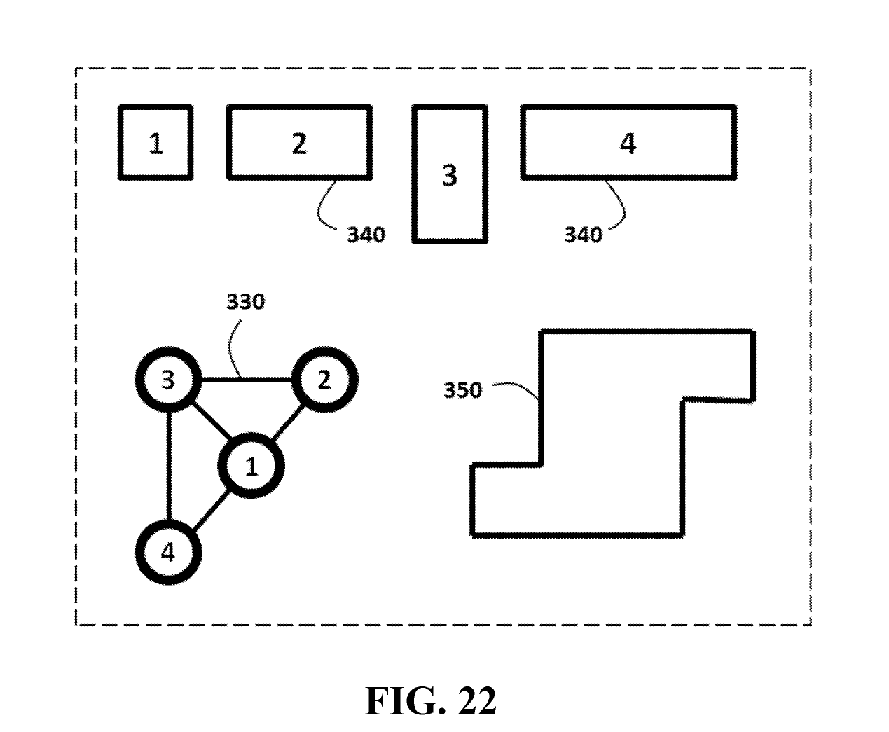

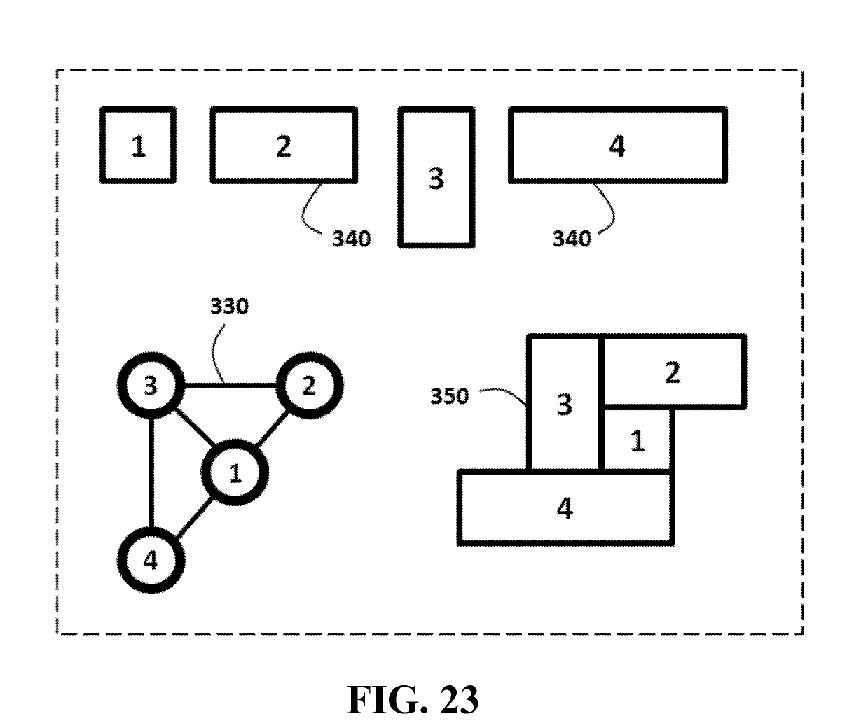

In another embodiment, the game problem includes a two-dimensional or three-dimensional container that the objects should fit inside it. For example, FIG. 22 illustrates an adjacency problem indicated by a bubble diagram 330, four objects 340, and container 350. In this case, the user's solution should fit the four objects inside the container as shown in FIG. 23. In one embodiment, some of the game objects are fixed objects that have a fixed position and cannot be moved by the user. In this case, the user moves the other objects of the game which need to be connected to the fixed object to solve the game problem. In yet another embodiment, the game problem requires separating or blocking some objects from the others while attaching some objects to the others.

In some problems of the game, each object has a certain area that can be represented by different shapes or dimensions. For example, an object in the form of a rectangle can have various combinations of widths and heights that form the rectangle's area. In this case, the user keeps trying these various combinations until reaching a solution that achieves the adjacency requirements designated by the problem. In other problems of the game, the user can rotate each one of the objects until they fit together to achieve the adjacency requirements.

Conclusively, while a number of exemplary embodiments have been presented in the description of the present invention, it should be understood that a vast number of variations exist, and these exemplary embodiments are merely representative examples, and are not intended to limit the scope, applicability or configuration of the disclosure in any way. Various of the above-disclosed and other features and functions, or alternative thereof, may be desirably combined into many other different systems or applications. Various presently unforeseen or unanticipated alternatives, modifications variations, or improvements therein or thereon may be subsequently made by those skilled in the art which are also intended to be encompassed by the claims, below. Therefore, the foregoing description provides those of ordinary skill in the art with a convenient guide for implementation of the disclosure, and contemplates that various changes in the functions and arrangements of the described embodiments may be made without departing from the spirit and scope of the disclosure defined by the claims thereto.

1. A method of gaming comprising:
presenting a problem comprised of adjacency requirements and a plurality of objects to be positioned relative to each other according to the adjacency requirement;
receiving a solution of a user representing the positions of the objects; and
checking the compliance of the positions against the adjacency requirements.

2. The method of claim 1 wherein the objects are virtual objects presented with the adjacency requirements on a computer display.

3. The method of claim 1 wherein the objects are real objects equipped with a display that presents the adjacency requirements and sensors that sense the position of the real objects relative to each other.

4. The method of claim 1 wherein the objects and the adjacency requirements are printed on paper.

5. The method of claim 1 wherein the adjacency requirements are represented by a bubble diagram.

6. The method of claim 1 wherein the adjacency requirements are represented by tags located on the objects and the tags include numerals or colors.

7. The method of claim 1 wherein the adjacency requirements are represented by a table or statement.

8. The method of claim 1 further the problem includes directions requirements related to the objects.

9. The method of claim 1 further the problem requires the objects to fit inside a container that has a particular shape or dimensions.

10. The method of claim 1 further each one of the objects has a specific area and can be represented by different shapes or dimensions.

11. The method of claim 1 wherein each one of the objects can be rotated.

12. The method of claim 1 wherein some of the objects have fixed positions and cannot be moved.

13. The method of claim 1 wherein the objects are two dimensional objects that can be positioned on a single plane.

14. The method of claim 1 wherein the objects are three dimensional objects that can be positioned on multiple planes located above each other.

15. The method of claim 1 wherein the objects are three dimensional objects that can be positioned in three-dimensions relative to each other.

16. A method of computer gaming comprising:
presenting virtual objects on a computer display wherein each one of the virtual objects contains one or more tags representing adjacency requirements between two or more virtual objects;
receiving an input of a user representing the positions of the virtual objects; and
checking the compliance of the positions against the adjacency requirements.

17. The method of claim 16 wherein the one or more tags disappear when the adjacency requirements are achieved.

18. The method of claim 16 wherein the virtual objects are two-dimensional objects and the adjacency requirements represent two-dimensional positioning requirements.

19. The method of claim 16 wherein the virtual objects are three-dimensional objects and the adjacency requirements represent three-dimensional positioning requirements.

20. The method of claim 16 wherein the adjacency requirements are represented by a bubble diagram, table or statements.
